(19) United States
(12) Patent Application Publication
(10) Pub. No.: US 2003/0089031 A1
(43) Pub. Date: May 15, 2003

(54) Edging border devices for plants, lawns and gardens

(76) Inventors: Kinfun Wong, San Jose, CA (US); Jinshyun Ruth Wu-Wong, San Jose, CA (US)

Correspondence Address: C. P. Chang, c/o Pacific Law Group LLP, Suite 290, 2 North Second Street, San Jose, CA, 95113, US

(21) Appl. No.: 10/288,898

(22) Filed: Nov. 5, 2002

Related U.S. Application Data
(60) Provisional application No. 60/333,048, filed on Nov. 13, 2001.

(51) Int. Cl. A01G 1/00

(52) U.S. Cl. 47/33

(57) ABSTRACT

Precast plastic or fiberglass landscape border building units that can be filled with substances such as water and/or other filling materials, and used as yard edging and fence, around trees, bushes, plants, and on lawns. The units are light and easy to move and/or carry, and, once assembled, are weighed down by filling materials to avoid ground movement. The units can be plain, hollow pieces in various shapes and colors. The units can also have protrusions and grooves that allow several pieces to be connected, assembled or stacked together using the protrusions or grooves. In addition, the units can have certain carved-out patterns or designs that allow plants to grow within the units.

### REFERENCE TO RELATED APPLICATION

This application claims the priority and other benefits from the filing date of an earlier U.S. Provisional patent application Ser. No. 60/333,048 entitled “EDGING BORDER DEVICES FOR PLANTS, LAWNS AND GARDENS” by the same inventor filed on Nov. 13, 2001.

### BACKGROUND OF THE INVENTION

The present invention relates to lightweight, connectible, hollow devices, and specifically pertains to the field of gardening, lawn edging, and lawn bordering to allow the growth of desirable plants in designated areas. It can also be used to define the edge of a planting area, to decorate a lawn or garden, to separate a lawn from a garden, to serve as a tree or bush skirt, to retain materials such as pine needles or bark or pebbles, or to serve as a fence or dividing structure. The hollow devices are of different materials, of various sizes, shapes and colors that, once constructed and placed in a desirable location, can be filled with substances such as water, sand, pebbles, marbles, and other materials to prevent ground movement. The devices are connectable and can be stacked into desirable structures using grooves and protrusions.

Various attempts have been made to serve the above-described purposes, but each has its shortcomings.

For example, edging devices made of solid wood, metal, poured concrete or cement are usually inflexible, heavy, and are difficult to move and handle. They are also difficult to repair once they are put in place.

Although the advantages of being flexible and easy to manipulate are evident in the devices that use plastic to make landscape edging blocks when compared to the aforementioned devices, problems nevertheless occur because the plastic blocks are not heavy enough to prevent ground movement.

Some devices that employ plastic blocks tried to solve the ground movement problem by using designs that can be driven into the ground to a predetermined depth. It usually involves digging a trench in the ground, inserting part of the block into the trench, refilling the trench, and compacting the earth around the structure. In some cases, anchoring devices are employed to secure the edging blocks to the ground. Even with these efforts, the edging runs the risk of being displaced out of its original position as time goes by, or when it is accidentally bumped or shoved.

Another example that describes molded plastic edging modules joined by a pair of male-female connectors also attempts to solve the ground movement problem by having flanges that extend outwardly from the side of the body. The flanges are covered by soil when the module is inserted into the ground to stabilize the module. Again, this example involves covering part of the module with soil, and runs the risk of displacing the module out of its original position as time goes by, or when it is accidentally bumped or shoved.

Other examples that describe plastic edging devices often require stakes for anchoring the devices into the soil and brackets and pins for locking the devices together. Some require the use of metal materials for locking as well as thin flanges and clips to prevent ground movement. The need to use brackets, pins, flanges and clips limits the ability of the devices to be made into any size, shape, and/or dimension. Consequently, the devices have to be molded into a specific form, such as an elongated body, a block, or a half circular form. In addition, constructing the devices into desirable structures requires considerable efforts from gardeners and landscapers.

Another example designed particularly to solve the ground movement problem provides a holding device for paving blocks. Such a device is used only for the purpose of holding the paving blocks and cannot serve other purposes.

Another lawn edger is formed using edging strips that require separate connectors and stakes to hold the edger in the ground. Such a design is even less flexible since it requires separate connectors and stakes for the installation of the edger.

None of the above-mentioned examples discloses lightweight and compact landscape structures that are built using connectable or stackable devices of various sizes, shapes and colors and that can be filled with substances such as water, pebbles, sand, or other filling materials to prevent ground movement.

### SUMMARY OF THE INVENTION

Therefore, there exists a need for compact, lightweight landscape border building devices that are hollow and can be filled with substances to provide weight, and that are easily connected and stacked.

The present invention meets these needs. The landscaping devices of the present invention are hollow, compact, lightweight, and connectible landscape border building units that can be filled with substances such as water, pebbles, sand, or other filling materials to provide weight necessary to prevent ground movement. These hollow devices are made of durable materials, such as plastic, including polypropylene and polyethylene, and are easy to move and handle. These devices can also be made of fiberglass, metal, hard rubber, tile, masonry, or natural materials such as wood, wood-byproducts, as long as they remain lightweight and easy to carry, and are able to hold filling materials to prevent ground movement. Each unit is equipped with a hole and a cap. Once assembled, the devices are weighed down by filling substance to avoid ground movement. The cap can be snapped on or screwed on to prevent leakage or loss of the substance, for example, through water evaporation. Because these devices do not require flanges or stakes, they can be made in any size, shape and color. They can be plain, hollow pieces in various sizes, shapes and colors. The devices can also have protrusions and grooves and/or pins and sockets through which several pieces are connected, assembled, or stacked together and constructed into a desirable structure. In addition, the devices can have certain carved-out patterns or designs that will allow plants to grow within each device.

The landscape devices of the present invention provide a means for building a structure to be used as yard edging around trees, bushes, plants; on lawns and gardens to define the edge of a planting area; to decorate a lawn or garden; to separate a lawn from a garden; to serve as a tree or bush skirt; to retain materials such as pine needles or bark or pebbles, and to serve as a fence or dividing structure. These devices are light and are easy to carry and handle and can be inter-connected or stacked. They can also be easily disassembled and changed into a structure of a different pattern or to replace a damaged piece. They provide the convenience and flexibility needed to achieve the desirable effect of creating a beautiful lawn or garden.

### BRIEF DESCRIPTION OF THE FIGURES

FIG. 1 shows an example of a plain, hollow, square block containing a hole and a cap for filling substances.

FIG. 2 shows an enlarged example of the hole and its snap-on cap as in FIG. 1.

FIG. 3A shows a hole and its cap. The cap is a separate unit.

FIG. 3B shows an example of the hole and its screw-on cap.

FIG. 4A shows an example of one type of the groove and protrusion in the shape of a half cylinder for fitting two square blocks together.

FIG. 4B shows an example of one type of the groove and protrusion in the shape of a full cylinder shape for fitting two square blocks together.

FIG. 5A shows an example of a different type of connectable structures such as dovetail pins and matching sockets.

FIG. 5B shows another example of a different type of connectable structures such as straight pins and matching sockets.

FIG. 6 shows an example of the groove and protrusion on different locations of a unit, which allow two blocks with square surfaces to be stacked on top of each other.

FIG. 7 shows an example of the groove and protrusion on different locations of the units, which allow units to be connected on all four sides.

FIG. 8 shows a triangular edging structure composed of 3 triangular units and 3 trapezoid units placed around the base of a plant.

FIG. 9 shows a circular edging structure composed of 4 quarter-circle units, that are connected to 4 smaller triangular structures shown in FIG. 8.

FIG. 10 shows a 24 cm×24 cm square block of 5 cm in height which has a 18 cm×18 cm carved-out square pattern in the middle of the block, allowing planting within the block. This type of unit is named “planting unit”.

FIG. 11 shows a square edging structure composed of plain square blocks and square “planting units” shown in FIG. 10. The structure is then placed around a tree.

FIG. 12 shows a structure made of individual units that are in the shape of a frog.

FIGS. 13A&B show how square units are anchored to the ground, and stacked together into a fence-like structure.

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well.

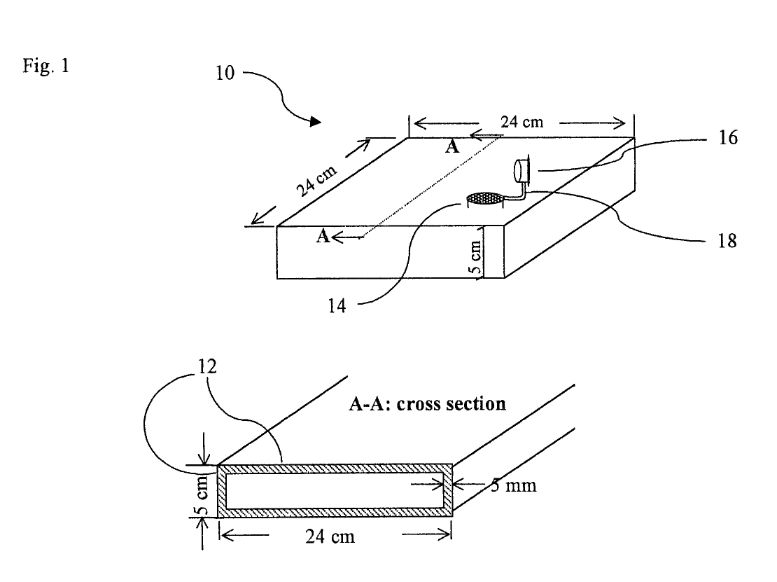

FIG. 1 shows an example of a plain, hollow block 10. The block 10 has 24 cm×24 cm square top and bottom surfaces and is 5 cm in height. The block 10 is hollow and its walls 12 made of plastic are 5 mm thick. The top surface of the block has a circular hole 14 with a 2 cm diameter for adding filling substances into the block. The hole 14, which is a circular structure of a 5 mm depth, can either extend above the surface of the block 10 or be located right beneath its surface. In FIG. 1, a cap 16 made of plastic with a diameter slightly smaller than 2 cm is connected to the filler hole by a neck 18. The cap 16 is snapped into the hole 14 like a plug to make an enclosed leak-proof unit. This unit can be made of plastic, fiberglass or other materials of different thickness, and can be of different colors, sizes, shapes and dimensions. Furthermore, the unit's wall thickness necessary to provide adequate strength according to design requirements will be determined by engineers.

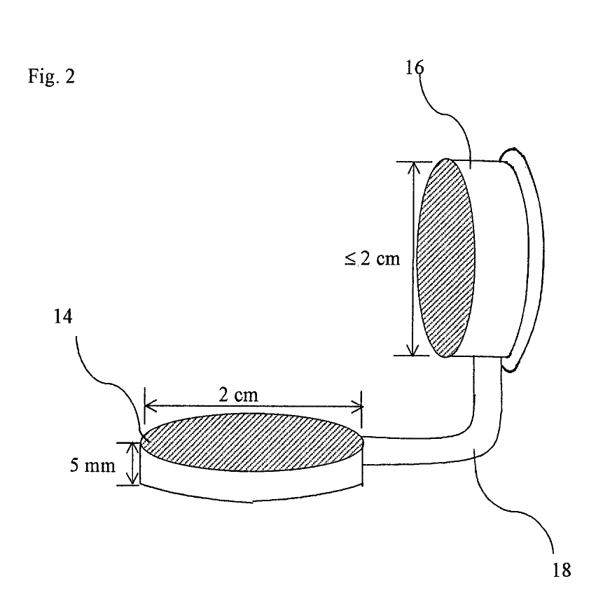

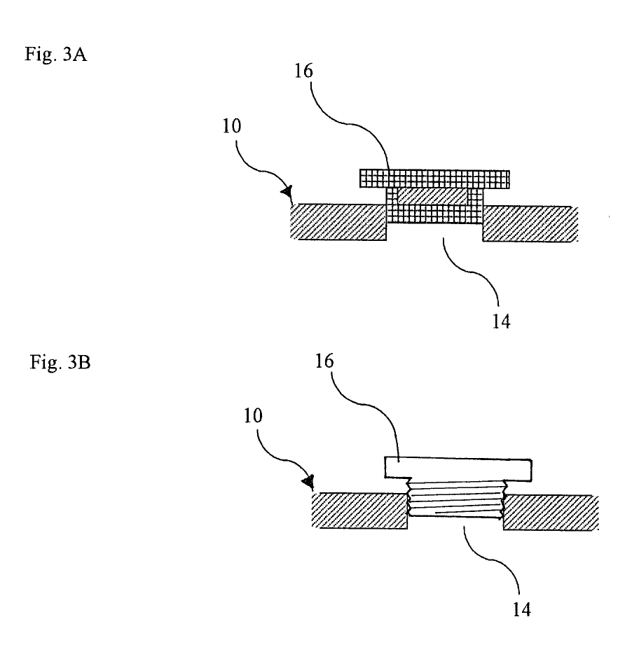

In FIG. 2, the hole 14 and its cap 16 shown in FIG. 1 are illustrated in more details. In this example, the hole 14 is circular with a diameter of 2 cm and allows addition of filling materials such as water, pebbles, sand, and marbles. The hole 14, a circular structure of 5 mm in depth, can either extend above the surface of the block or be located immediately below the surface. The cap 16 is also circular with a diameter slightly smaller than 2 cm to allow it to fit into the hole 14. The cap 16 is connected to the unit block by a neck 18 of 5 mm in width and 2 cm in length. The cap 16 can be snapped into the hole 14 like a plug to prevent leakage and loss of the filling materials. The hole 14 and its cap 16 can also be of other shapes, and sizes. For example, the cap 16 does not need to be connected to the unit, and can form a separate unit (FIG. 3A). The cap 16 can also be screwed on to the hole 14 as shown in FIG. 3B.

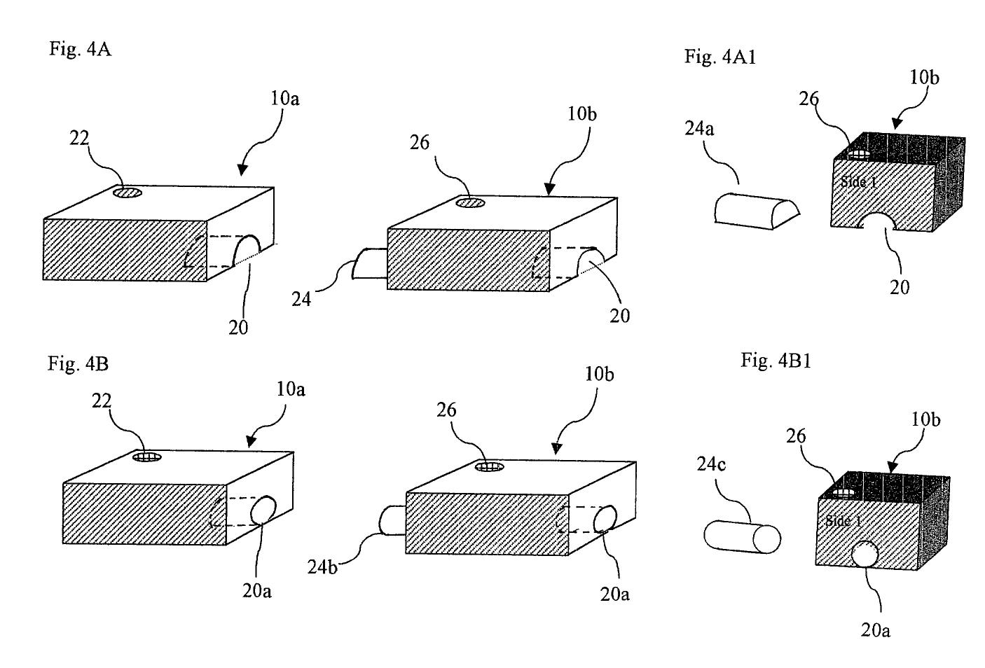

FIG. 4A shows an example of a first square-surfaced block 110a with a groove 20 and a second square block 210b with a protruding pin 24 that can fit into the groove 20 on the first block 110a. In this example, the groove 20 is located in the middle of the bottom right side of the first block 110a. The groove 20 is in the shape of a half cylinder and has a diameter of 3 cm and a length of 6 cm. The protruding pin 24 is also in the shape of a half cylinder and has a diameter slightly smaller than 3 cm and protrudes slightly less than 6 cm outside block 210b, which will allow it to be fit into the groove 20 on block 110a. If necessary, the protruding pin 24 can be broken off without affecting the integrity of block 210b. The protruding pin 24a can also be a loose, separate piece of plastic or other material, which can fit into the groove 20 on the first block 110a and a similar groove on the second block 210b to hold the two blocks together once the blocks are placed on the ground (FIG. 4A1). FIG. 4B and FIG. 4B1 show a similar design except that pin 24b or pin 24c and its matching socket 20a are in the shape of a full circular cylinder. In addition, pins 24, 24a, 24b and 24c and sockets 20 and 20a can be placed at locations other than the middle of the bottom of a block. The hole and cap 22 on block 110a and the hole and cap 26 on block 210b are the same as described before.

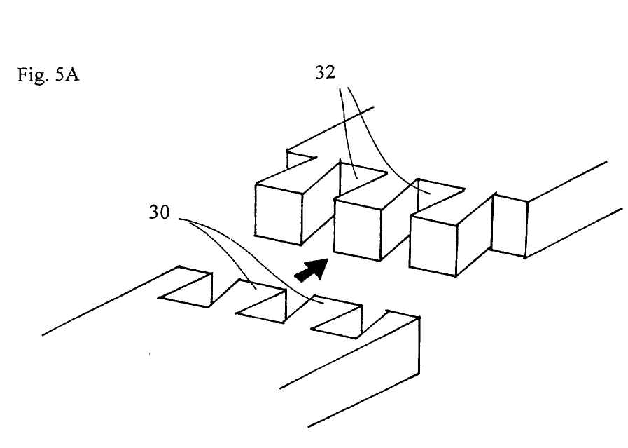

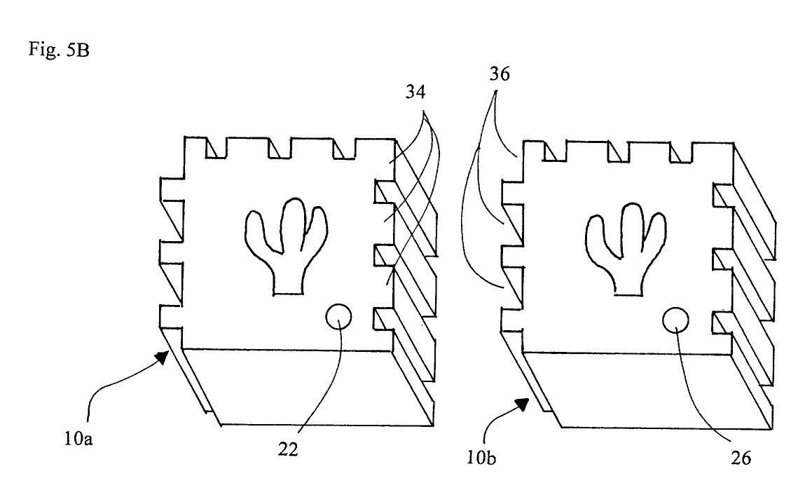

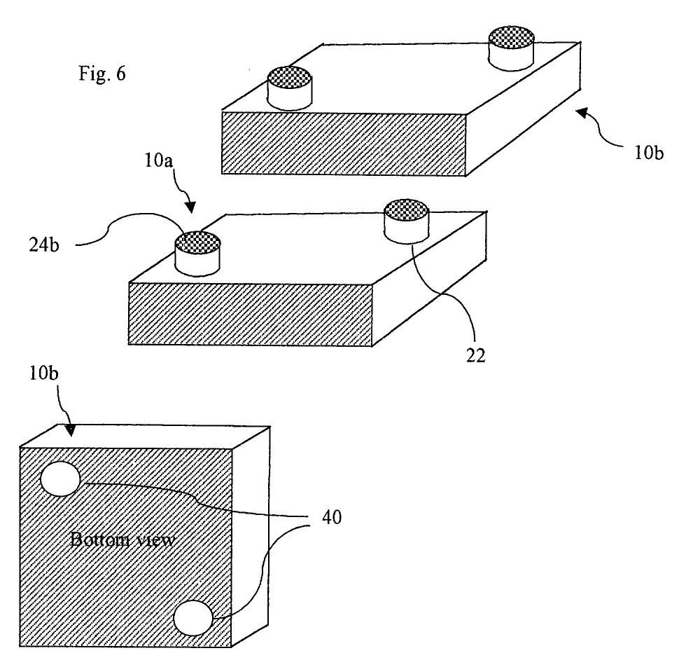

The unit can be equipped with different types of connectable structures such as a hook and a hole, dovetail pins 30 and matching sockets 32 as shown in FIG. 5A, or straight protrusions 34 and matching sockets 36 as shown in FIG. 5B. FIG. 5B also intends to show that blocks 10a and 10b can have painted or carved-out patterns such as a cactus.

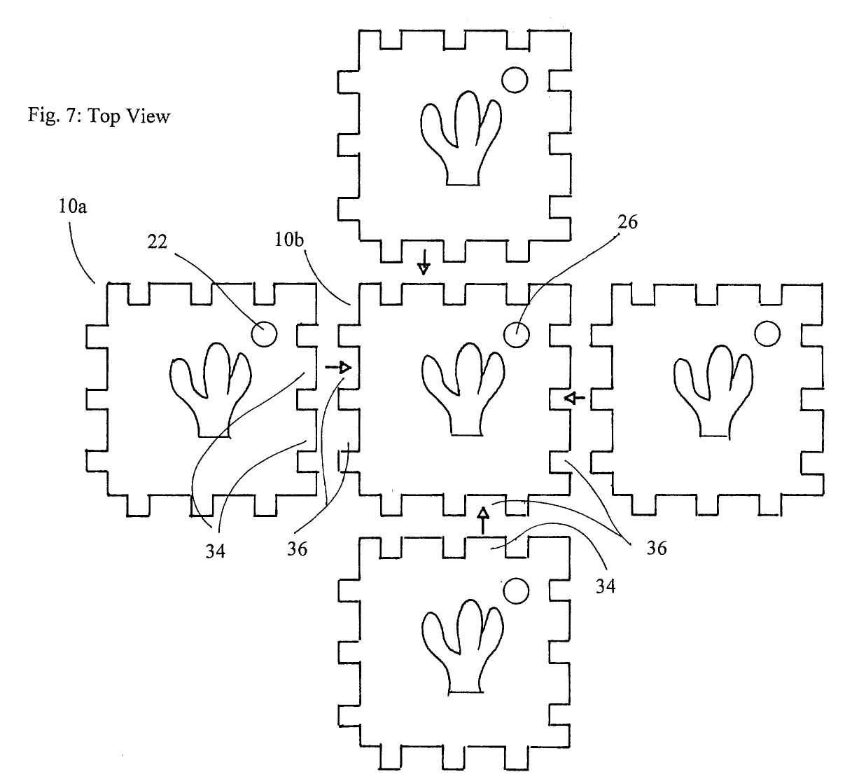

The unit can also be equipped with grooves and protrusions on different locations of the unit, which will allow units to be stacked on top of each other. In an example shown in FIG. 6, two square blocks 10a and 10b are stacked on top of each other. The protruding pin 24b and hole and cap 22 on block 110a fit into matching holes 40 on block 210b to connect the two blocks together. The blocks can also be connected on all four sides (FIG. 7). In this example, each block has straight protrusions 34 and matching sockets 36 of various sizes on 4 sides, which allow several of them to be connected together. The cactus can be painted patterns on the block. There can also be carved-out patterns in the block to allow growth of small plants within the block. The details of this type of protrusions and sockets are shown previously (e.g. FIG. 5).

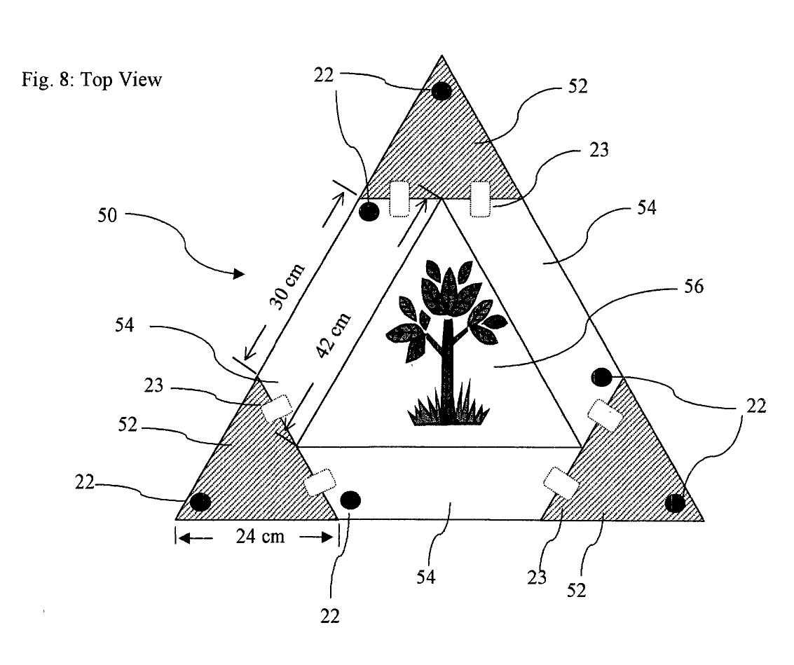

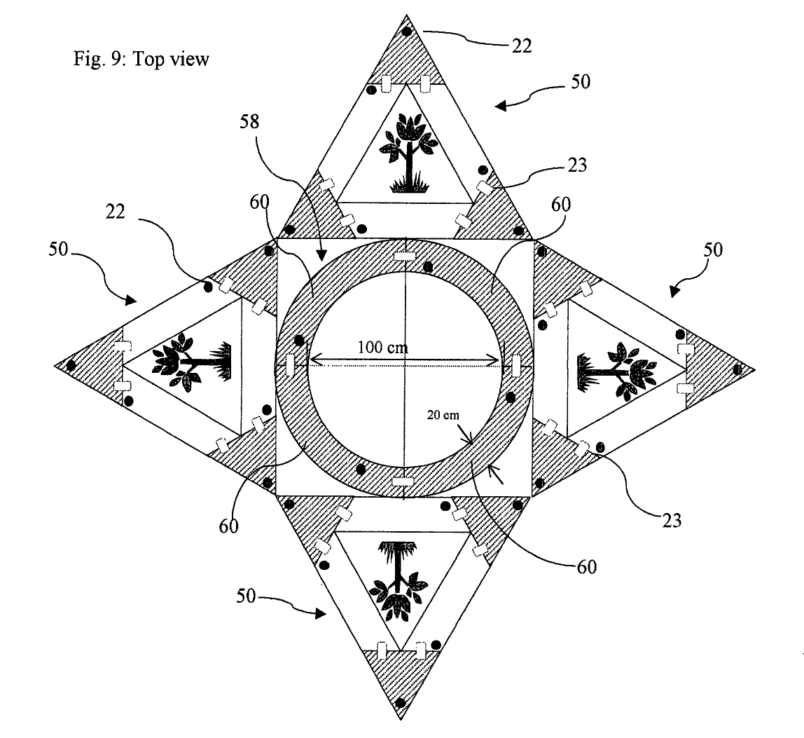

In FIG. 8, a triangular edging structure 50 is put together by laterally or horizontally connecting 3 triangular units 52 together with 3 trapezoid units 54 placed around the base of a plant 56. Each side of the triangular unit 52 is 24 cm. Each trapezoid unit 54 is 30 cm by 42 cm. The units 52 and 54 can be connected by one or more connecting means 23 such as the grooves and protrusions according to the method shown previously (e.g. FIG. 4 and FIG. 5). Once the desirable structure is formed, filling materials are added into each unit to prevent ground movement, and the hole 22 of each of the units 52 and 54 is closed to prevent loss and leakage. FIG. 9 shows a lateral or horizontal circular edging structure 58 made of 4 quarter-circle units 60, or alternatively 2 half-circle units although not shown here. Four units 50 are connected to unit 58 by one or more of the connecting means 23 such as the grooves and protrusions as shown in previous figures. The diameter of the final circular structure 58 is 140 cm while the diameter for the inner circle is 100 cm. Using different shapes of units, a structure can be of any shape such as triangle, circle, square, etc. In addition, different edging structures can be put together to achieve desirable design effects as shown in FIG. 9, in which 4 smaller triangular structures 50 are placed adjacent to a large circular structure 58.

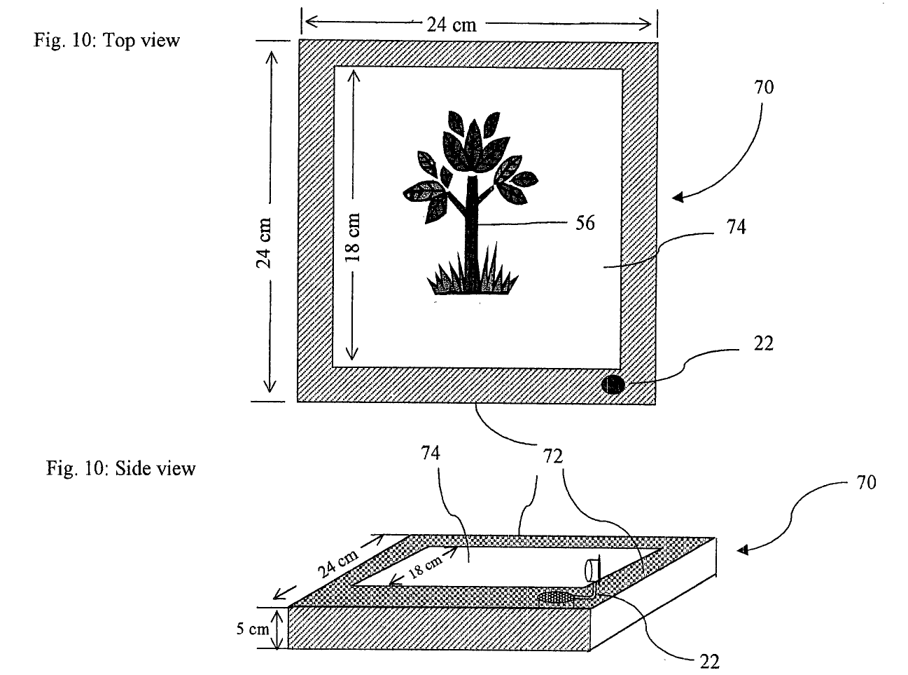

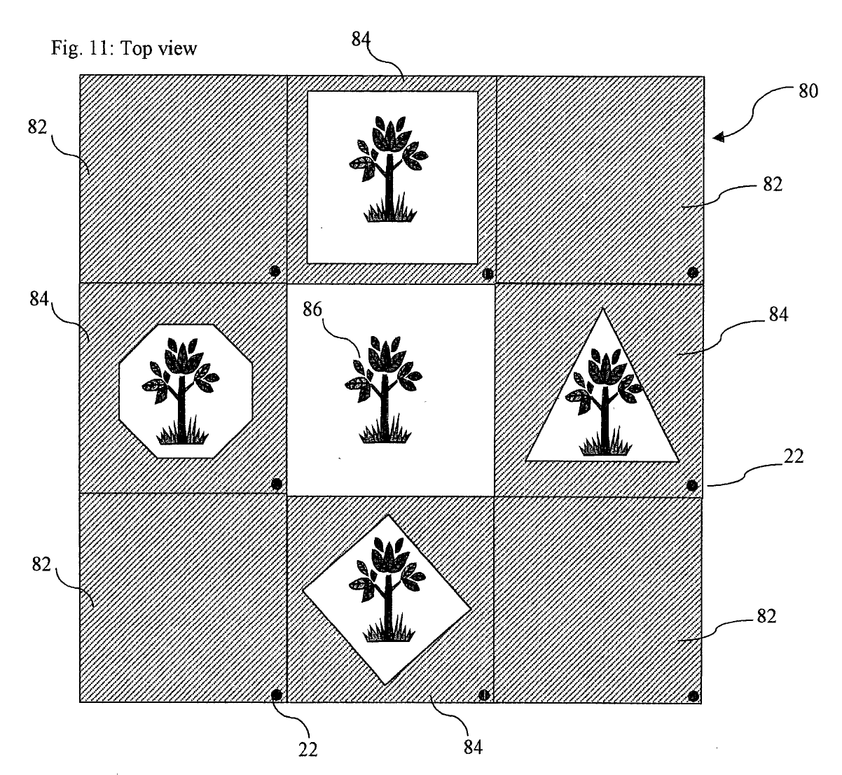

If desired, the unit can be designed with carved-out pattern and space within the unit which allows planting within the unit. FIG. 10 shows a square block 70 which has a height of 5 cm and the dimension of 24 cm×24 cm as in FIG. 1. However, this block 70 is not plain like the one in FIG. 1. This block 70 is actually a frame 72 with a center dimension of 18 cm×18 cm. The 18 cm×18 cm space 74 in the center of the block 70 is large enough to allow growing plants 56. Except for the space 74 within the block 70, the block 70 has all other designs of a plain block 10 as in FIG. 1. The carved-out pattern or space 74 in a “planting unit” can be of different shapes such as triangle, circle, and square. In addition, a planting unit can be of any design or pattern with more than one space or hole within the unit to allow different types of plants to be grown into desirable pattern.

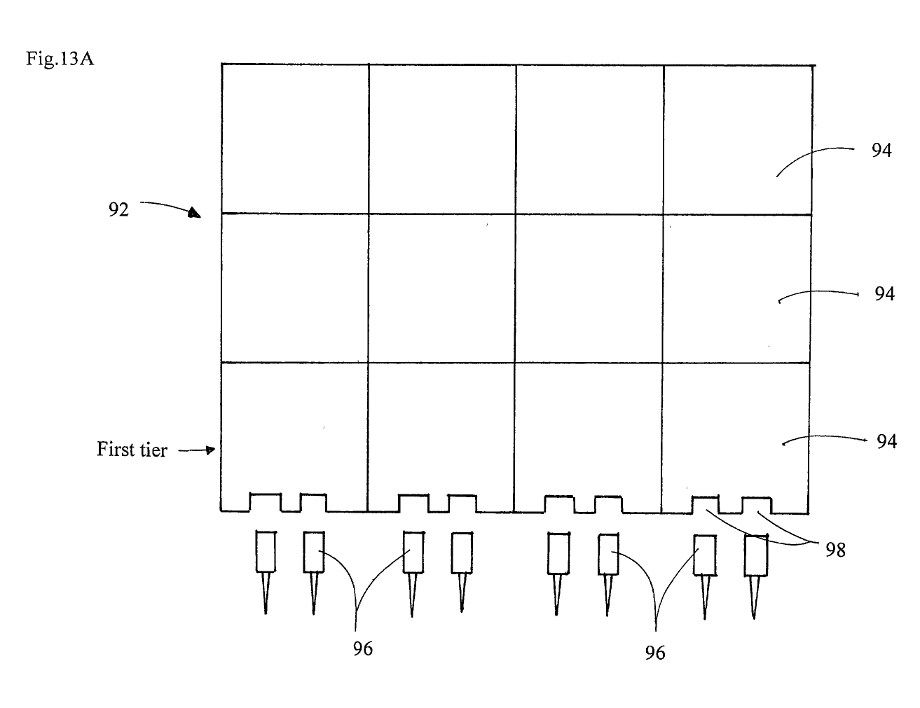

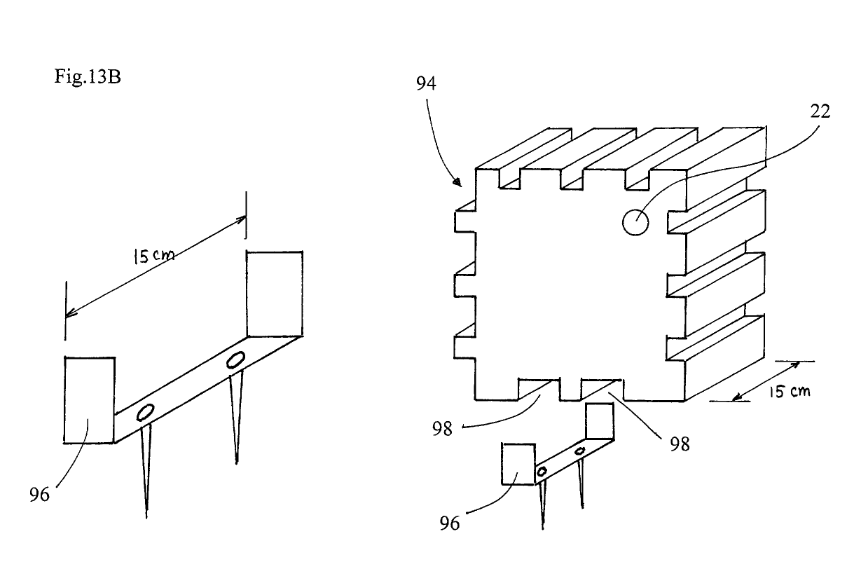

FIG. 11 shows a lateral or horizontal square structure 80 which is made of 4 plain units 82 and 4 “planting units” 84. The units 82 and 84 are connected together by grooves and protrusions as shown in previous figures. When such a structure is placed around a tree 86, other plants such as flowering bushes can be grown within “planting units” 84 to achieve desirable effects. Plain units 82 and “planting units” 84 can be stacked on top of each other in a manner similar to what is illustrated in FIG. 13 in order to grow some plants at a certain height.

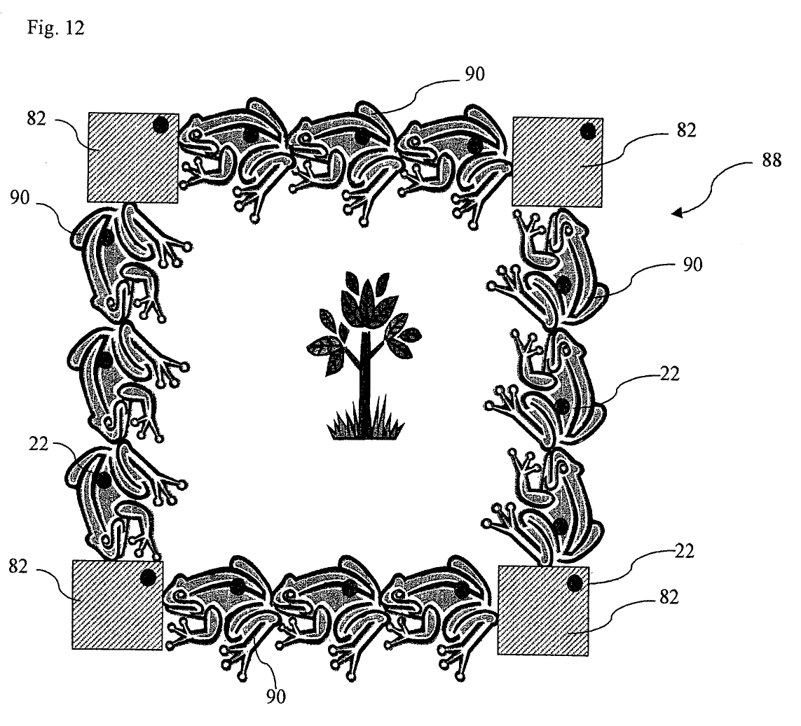

The units 82 and 84 can be of any shape (i.e. other than geometrical shapes), and of any size, color, and pattern. As an example, FIG. 12 shows a structure 88 made of units 90 in the shape of a frog. Each block 82 or each unit 90 is approximately 24 cm×24 cm×5 cm. The device can be utilitarian products and/or lighthearted, fun products.

The units can be stacked vertically to form a fence-like structure 92 as shown in FIG. 13A. In this example, cubic blocks 94 are connected vertically instead of horizontally via grooves and protrusions as shown in previous figures. If necessary, the first tier of blocks is connected to braces and anchors 96 that are inserted into the ground to secure the structure (FIG. 13B). The grooves 98 at the bottom of a block in the first tier can fit in with a corresponding number of braces and anchors 96. Planting units can be stacked at the very top of the fence 92 in order to grow some plants at a certain height. Blocks in the bottom tiers can be filled completely with substances while blocks in the top tiers can be partially filled with substances to avoid unnecessary weight added to the blocks at the bottom tier. The thickness and length of the braces and anchors 96, the number of braces and anchors, and the thickness and size of the blocks 94 pertaining to the design requirement for adequate strength will be determined by engineers.

The whole lawn or garden can be decorated by using different shapes and colors of structures made of various units. For example, a fence surrounding the lawn or garden is erected using blocks and anchors. A second structure can be used to separate the lawn from the garden area. Within the garden, areas for trees and bushes are further defined by using structures made of yet more units. The structures provide means for defining the edge of a planting area, for decorating a lawn/garden, for separating a lawn from a garden, for serving as a tree or bush skirt, for retaining materials such as pine needles or barks or pebbles, and for serving as a fence or dividing structure.

The units can be transparent. Once constructed, they are filled with substances of different colors to achieve desired dramatic effects.

We claim:

1. A compact, lightweight, and leak proof landscape bordering and edging device comprising:
at least one cavity defined by an enclosure with enclosure walls surrounding said cavity; at least one filling and capping means located on said enclosure walls and in communication with said at least one cavity; and an optional filling substance being filled and capped within said cavity through said filling and capping means.

2. The landscape bordering and edging device of claim 1 wherein said enclosure walls are made with a durable plastic material.

3. The landscape bordering and edging device of claim 2 wherein said durable plastic material is polypropylene or polyethylene.

4. The landscape bordering and edging device of claim 1 wherein said enclosure walls are made with a material selected from the group consisting of fiberglass, metal, hard rubber, tile, masonry, wood and wood-by-products.

5. The landscape bordering and edging device of claim 1 wherein said enclosure walls are made of a transparent material so as to allow the color of said filling substance to show through thus achieving a desired visual effect.

6. The landscape bordering and edging device of claim 1 wherein the size, shape and color of said enclosure are chosen to fit a pre-determined landscape environment.

7. The landscape bordering and edging device of claim 1 wherein said filling substance is a medium for plant growth and said enclosure walls are made of carved-out surfaces to allow the growth of plants there from with the resulting landscape device being called a planting unit.

8. The landscape bordering and edging device of claim 1 wherein said enclosure walls are made with painted or carved-out surfaces to satisfy a pre-determined esthetic requirement.

9. The landscape bordering and edging device of claim 1 further comprising a number of interconnecting means located on said enclosure walls for interconnecting, in a manner allowing easy future disconnection, a number of said landscape devices to form a predetermined spatial layout pattern.

10. The landscape bordering and edging device of claim 9 wherein said predetermined spatial layout pattern is a pattern lying on a ground plane.

11. The landscape bordering and edging device of claim 9 wherein said predetermined spatial layout pattern is a pattern resembling a fence.

12. The landscape bordering and edging device of claim 11 wherein a number of said landscape devices located higher up along the fence altitude are selected to be planting units thus providing a corresponding visual effect of growing plants at a height.

13. The landscape bordering and edging device of claim 9 wherein, owing to the weight of said filling substance, those landscape devices resting on a ground are completely filled with said filling substance thus eliminating an otherwise needed anchoring features and associated installation steps while those landscape devices located higher up are only partially filled with said filling substance thus eliminating an unnecessary load on those landscape devices closer to the ground.

14. The landscape bordering and edging device of claim 1 wherein said filling substance is selected from a group consisting of water, pebbles, marbles and sand to simultaneously provide a strength to said landscape device against cracking and to prevent a ground movement beneath said landscape device.

15. The landscape bordering and edging device of claim 1 wherein said enclosure is of any size, shape and color.

16. A method of implementing a landscape bordering and edging design comprising:
a. providing a landscape bordering and edging design;
b. providing a corresponding total number of landscape bordering and edging devices with each landscape device having a number of interconnecting means and at least one cavity surrounded by an enclosure, wherein the size, shape and color of said enclosure are chosen to fit said landscape bordering and edging design, having enclosure walls and at least one filling and capping means for filling and enclosing said cavity with a filling substance there through; and
c. concurrently filling and enclosing a selected number of the total number of landscape devices with a filling substance of choice and interconnecting said total number of landscape devices through said interconnecting means to form a predetermined spatial layout pattern.
